(19) United States
(12) Patent Application Publication
(10) Pub. No.: US 2026/0131999 A1
(43) Pub. Date: May 14, 2026

(54) TRANSPORT SKID FOR COOLING MODULE

(71) Applicant: Air Burners, Inc., Palm City, FL (US)

(72) Inventor: Brian M. O'CONNOR, Palm City, FL (US)

(21) Appl. No.: 19/361,954

(22) Filed: Oct. 17, 2025

Related U.S. Application Data
(60) Provisional application No. 63/718,817, filed on Nov. 11, 2024.

(51) Int. Cl. B66C 1/10

(52) U.S. Cl. CPC B66C 1/104

(57) ABSTRACT

A transport skid apparatus for deploying a cooling module at a jobsite has a plurality of risers, a skid base, a pair of riser storage brackets fixed to the skid base, and a plurality of riser setup brackets fixed to the skid base. Each riser has a horizontal support member and a pair of riser legs. The skid base has a pair of longitudinal side skid members and a plurality of transverse cross-members connecting the side skid members. The riser storage brackets removably receive the plurality of risers in a transport configuration, and the riser setup brackets removably receive the plurality of risers in a support configuration to support a cooling module. The riser storage brackets are configured to concentrate the risers adjacent one another in the storage configuration. The riser setup brackets are positioned such that the risers are spaced apart along the skid base in the support configuration.

### CROSS-REFERENCE TO RELATED APPLICATION

The present application claims priority to and benefit of U.S. Provisional Patent Application No. 63/718,817 filed Nov. 11, 2024, the entire disclosure of which is incorporated herein by reference.

### FIELD OF THE DISCLOSURE

The present disclosure relates to a transport skid apparatus for transporting a cooling module to a jobsite and supporting the cooling module above ground at the jobsite.

### BACKGROUND OF THE DISCLOSURE

It is known to clear a site of biomass such as vegetative waste by collecting the vegetative waste and burning it in a firebox, for example an air curtain firebox that minimizes release of particulates during burning. The firebox may be a transportable module mounted on a skid base for over the road and off road trailer transport to a jobsite remote from the established public power grid, for example a site within a forest and/or in rough terrain.

It is also known to provide a portable power generating module locatable adjacent the firebox module that captures and uses hot exhaust from the firebox to generate electrical power, as taught by U.S. Pat. No. 9,644,501. The power generating module may use captured exhaust heat to drive an organic Rankine cycle (“ORC”) unit to generate electric power. Such an ORC unit circulates a coolant such as cold water pumped from a local water source, cooling tower, or other device to a condenser for condensing a working fluid of the ORC unit. At jobsites where a preexisting coolant source such as a pond is not available, it may be advantageous to transport a cooling module to the jobsite for connection to the power generating module to circulate coolant through the ORC unit. For example, an Alfa Laval ACE Model V air cooled heat exchanger having a compact footprint may be suitable for this purpose.

Once the cooling module is transported to the jobsite, it is advantageous to support the cooling module at an elevated position above ground level to keep the cooling module away from dirt and dust at the jobsite and thereby allow the cooling module to operate more efficiently.

Providing a compact apparatus that allows a cooling module to be lifted by crane, dragged around a site by tractor, and pulled by a winch onto a trailer for roadway transport is an unmet need. Such an apparatus should also facilitate supporting the cooling module above ground level at the jobsite and connecting piping thereto.

### SUMMARY OF THE DISCLOSURE

The present disclosure provides a transport skid apparatus useful for deploying a cooling module at a jobsite. In one embodiment, the transport skid apparatus generally comprises a plurality of risers, a skid base, a pair of riser storage brackets fixed to the skid base, and a plurality of riser setup brackets fixed to the skid base. The risers each have a horizontal support member and a pair of riser legs coupled to the support member. The skid base has a front end and a rear end spaced in a longitudinal direction from the front end, and includes a pair of longitudinal side skid members and a plurality of transverse cross-members connecting the pair of side skid members to one another. The pair of riser storage brackets are configured to removably receive the plurality of risers in a transport configuration of the transport skid apparatus, and the plurality of riser setup brackets are configured to removably receive the plurality of risers in a support configuration of the transport skid apparatus to support a cooling module. The pair of riser storage brackets are configured such that the plurality of risers are concentrated adjacent one another in the storage configuration, and the plurality of riser setup brackets are positioned such that the plurality of risers are spaced apart from one another along a length of the skid base in the support configuration.

The riser setup brackets may include associated pairs of facing setup brackets. Each associated pair of facing setup brackets may be fixed to one of the pair of longitudinal side skid members and arranged to receive a portion of one of the pair of riser legs of one of the risers therebetween. Each associated pair of facing setup brackets and each riser leg portion received therebetween may be configured for securing the riser leg portion between the associated pair of facing setup brackets using threaded fasteners.

Each of the pair of riser storage brackets may include a releasably attachable clamping rail for securing the plurality of risers in the riser storage bracket during transport.

The transport skid apparatus of the present disclosure enables transport of a cooling module to a jobsite and subsequent set up of the cooling module at the jobsite in an organized and efficient manner. Similarly, breakdown and transport of the cooling module from the jobsite is facilitated.

### BRIEF DESCRIPTION OF THE DRAWING VIEWS

The nature and mode of operation of the present disclosure will now be more fully described in the following detailed description taken with the accompanying drawing figures, in which:

FIG. 1 is a generally rear perspective view of a transport skid apparatus formed in accordance with an embodiment of the present disclosure, wherein the apparatus is in a transport configuration;

FIG. 2 is a view similar to that of FIG. 1, wherein the apparatus is in a support configuration;

FIG. 3 is a generally front perspective view showing the apparatus in the transport configuration with a cooling module and lift cables coupled thereto;

FIG. 4 is a generally rear perspective view showing the apparatus in the transport configuration with the cooling module and lift cables coupled thereto;

FIG. 5 is a generally front perspective view showing the apparatus in the support configuration with the cooling module thereon;

FIG. 6 is a generally rear perspective view showing the apparatus in the support configuration with the cooling module thereon;

FIG. 7 is a side elevational view of the apparatus and the cooling module in the transport configuration;

FIG. 8 is another side elevational view of the apparatus and the cooling module in the transport configuration;

FIG. 9 is a top plan view of the apparatus and the cooling module in the transport configuration;

FIG. 10 is a front elevational view of the apparatus and the cooling module in the transport configuration;

FIG. 11 is a top plan view of a skid base frame of the transport skid apparatus shown in FIG. 1;

FIG. 12 is a sectional view taken generally along the line A-A in FIG. 11;

FIG. 13 is a top plan view of a skid base of the transport skid apparatus shown in FIG. 1;

FIG. 14 is a side elevational view of the skid base shown in FIG. 13;

FIG. 15 and FIG. 16 are elevational views of the skid base showing dimensional fit with risers of the transport skid apparatus;

FIG. 17 is a top plan view of the transport skid apparatus shown in FIG. 1, wherein the apparatus is in the transport configuration;

FIG. 18 is a is a sectional view taken generally along the line A-A in FIG. 17;

FIG. 19 is a front elevational view of the apparatus without the cooling module in the support configuration;

FIG. 20 is a side elevational view of a pipe assembly stanchion of the apparatus;

FIG. 21 is a perspective view of a riser of the apparatus according to an embodiment of the present disclosure;

FIG. 22 is a side elevational view of the riser shown in FIG. 21;

FIG. 23 is a detailed view of portion A in FIG. 22;

FIG. 24 is a top plan view of the riser in FIG. 21;

FIG. 25 is a front elevational view of the riser shown in FIG. 21;

FIG. 26 is a perspective view of a riser storage bracket of the apparatus according to an embodiment of the present disclosure;

FIG. 27 is a perspective view of a tall riser setup bracket of the apparatus according to an embodiment of the present disclosure;

FIG. 28 is a rear elevational view of the tall riser setup bracket shown in FIG. 27;

FIG. 29 is a perspective view of a short riser setup bracket of the apparatus according to an embodiment of the present disclosure; and

FIG. 30 is a rear elevational view of the short riser setup bracket shown in FIG. 29.

### DETAILED DESCRIPTION

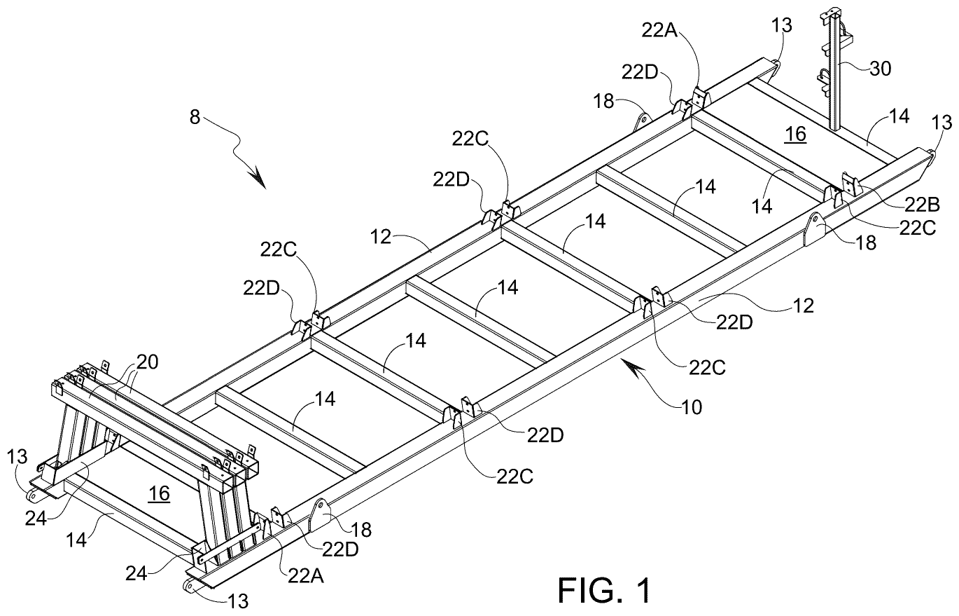

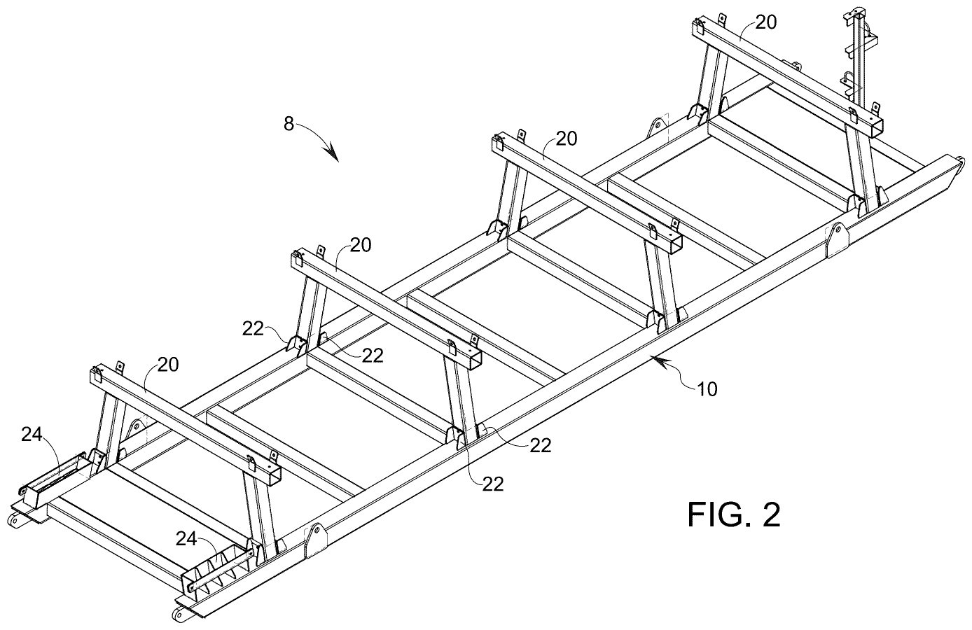

FIGS. 1 and 2 show a transport skid apparatus 8 formed in accordance with an embodiment of the present disclosure in a transport configuration and a support configuration, respectively. Transport skid apparatus 8 generally comprises a skid base 10 and a plurality of risers 20, and may further comprise a pipe assembly stanchion 30. In the transport configuration of FIG. 1, risers 20 are held closely adjacent to one another on skid base 10, and in the support configuration of FIG. 2, risers are held at spaced intervals along the length of skid base 10.

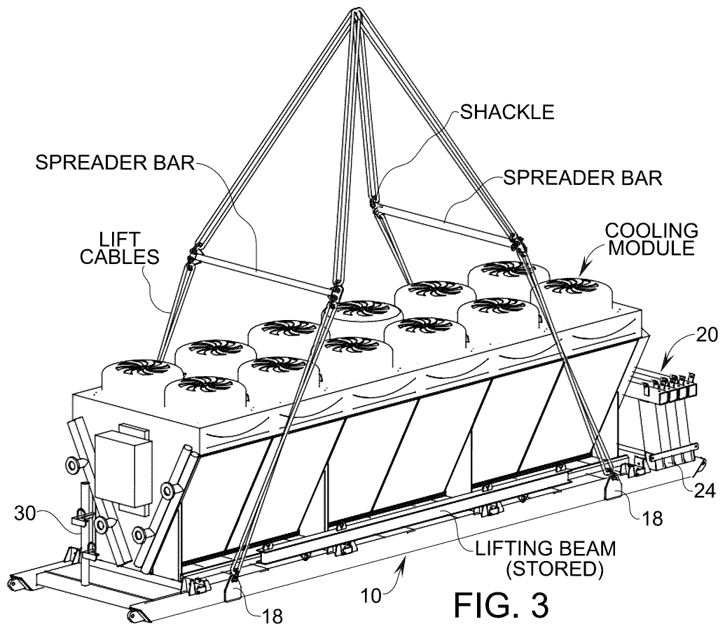

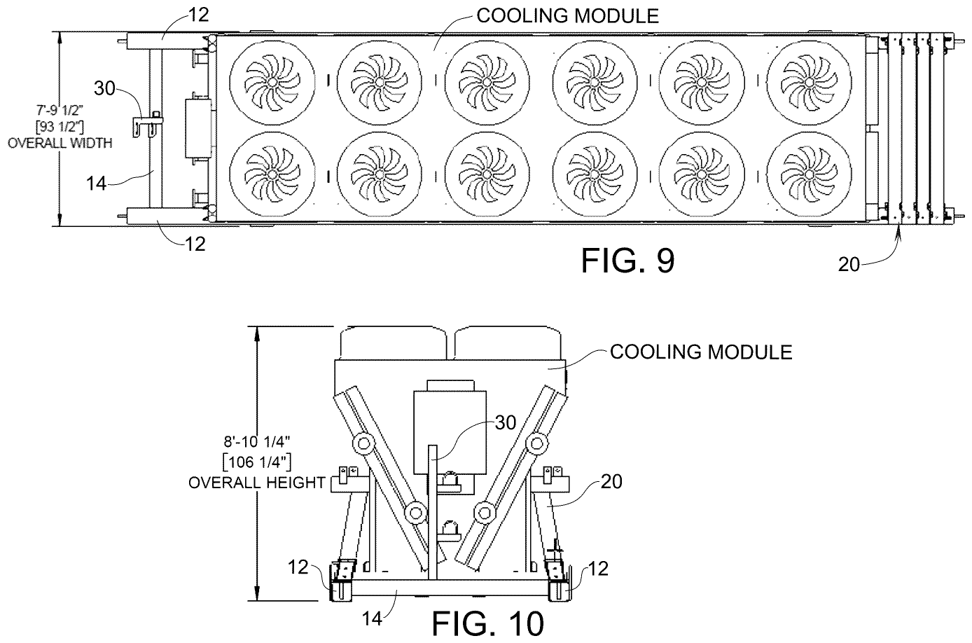

FIGS. 3, 4, and 7-10 show transport skid apparatus 8 together with a cooling module carried thereby, wherein transport skid apparatus 8 is in the transport configuration for transporting the cooling module. As will be described in greater detail below, transport skid apparatus 8 is designed for portability of the cooling module such that the apparatus 8 and cooling module may be hoisted onto and off of a truck bed for road transportation and dragged on the ground for positioning at a jobsite.

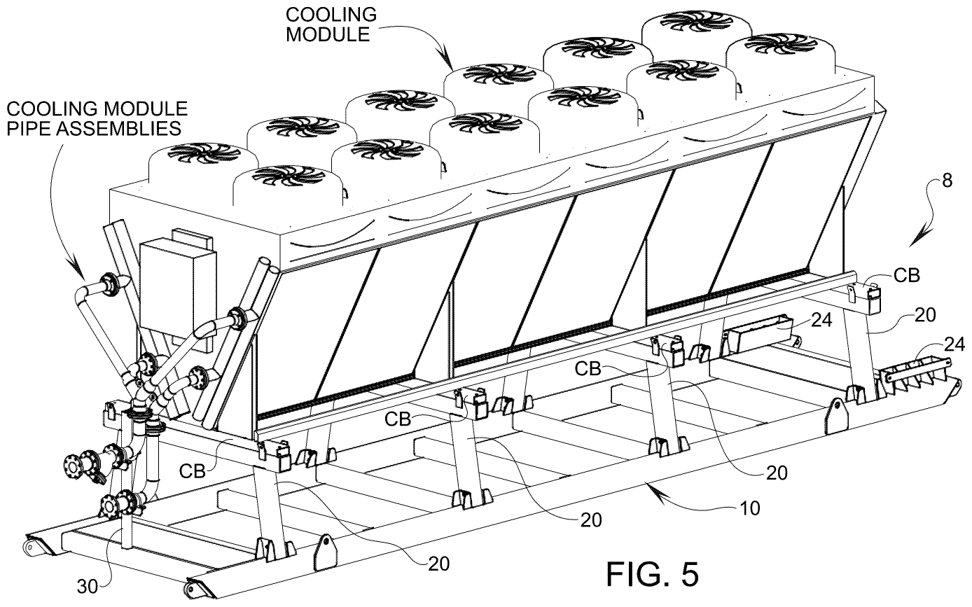

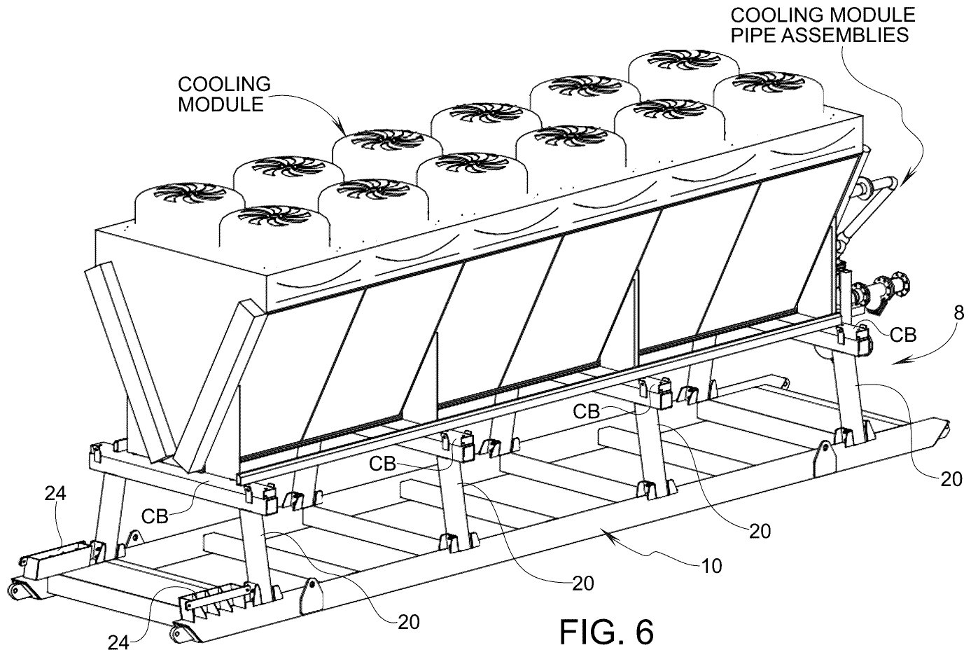

FIGS. 5 and 6 show transport skid apparatus 8 together with the cooling wherein apparatus 8 is in its support configuration for supporting the cooling module above ground level at a jobsite. As described below, risers 20 may be installed at spaced intervals along the skid base to support the cooling module above ground level when the cooling module is in use at a jobsite.

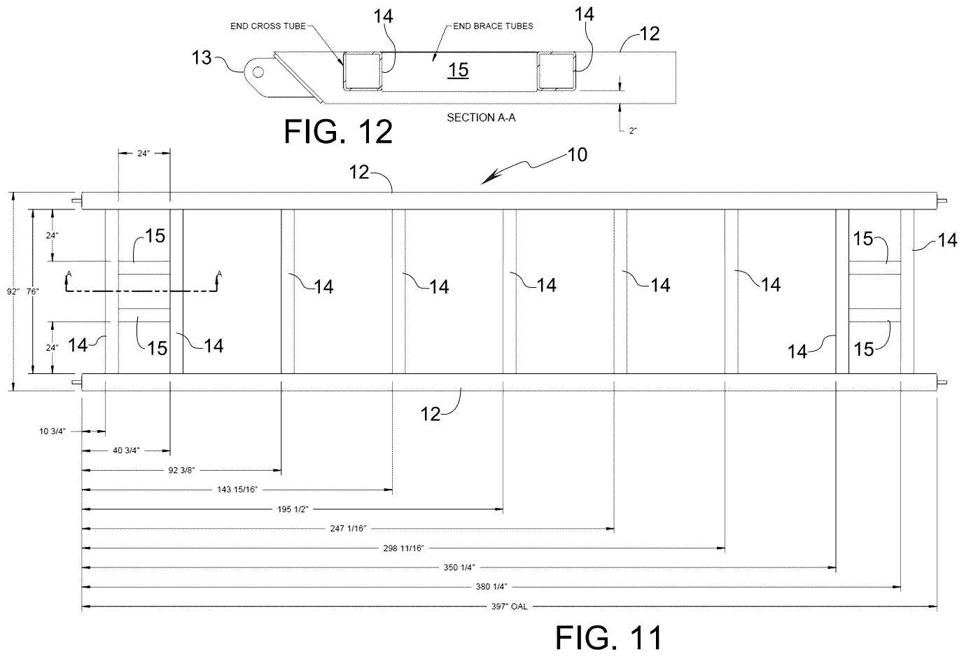

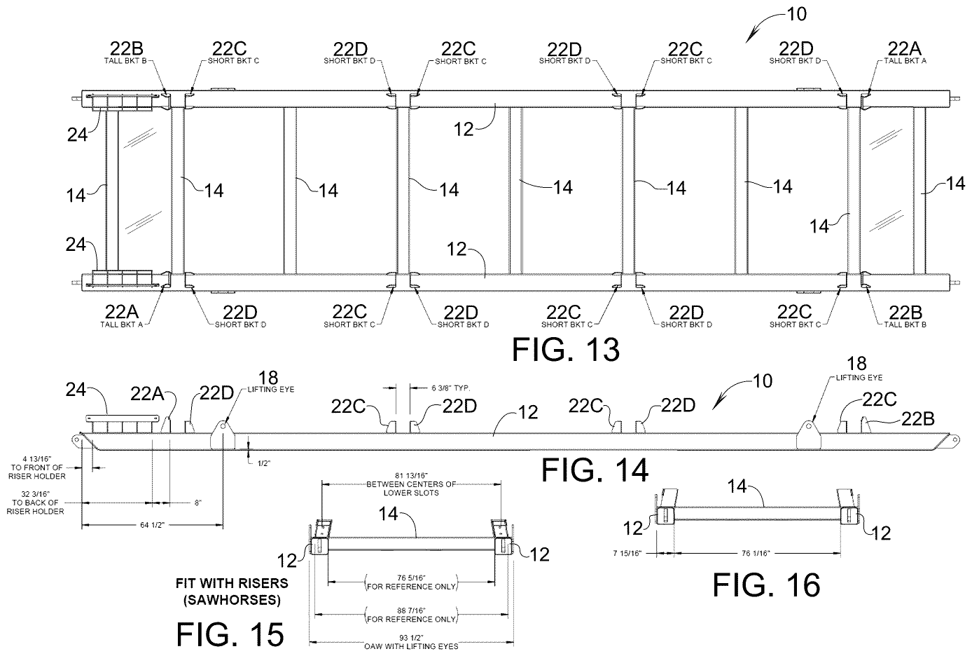

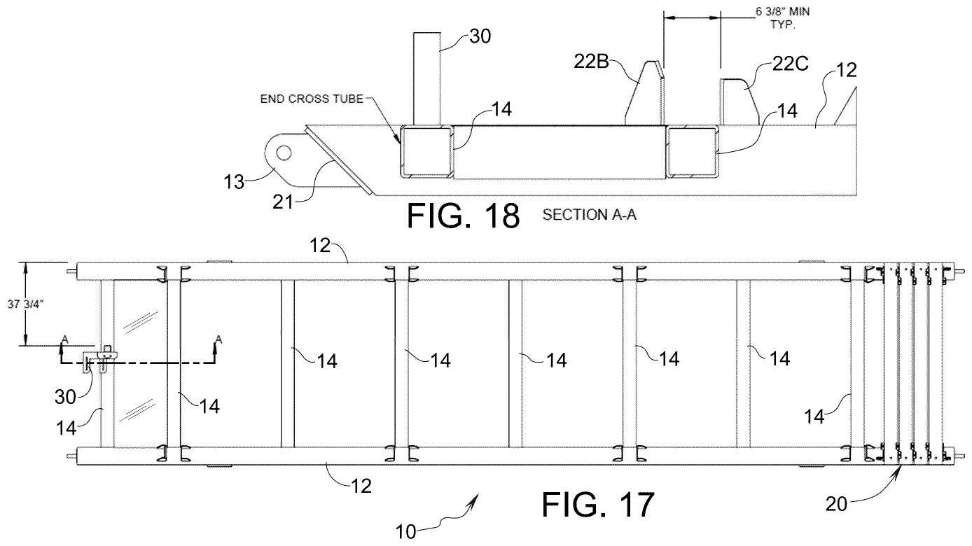

Reference is made now to FIGS. 11-17 in addition to FIGS. 1-10 for description of skid base 10. Skid base 10 may be a steel weldment that is generally rectangular in overall shape and has a skid base frame including a pair of transversely spaced side skid members 12 connected by a plurality of cross-members 14 and two pairs of longitudinal support beams 15 extending between adjacent cross-members 14 at a front end and at a rear end of skid base 10. A pair of floor plates 16 may be supported on longitudinal support beams 15 to cover respective areas between side skid members 12 and adjacent cross-members 14 at the front and rear ends of skid base 10. The front and rear ends of side skid members 12 may be configured to provide a sloped leading surface 21. An attachment member 13 may be arranged to extend forwardly from each leading surface 21 and may each include an attachment hole therethrough. Attachment members 13 are useful for connecting cables, e.g., using shackle couplings, to skid base 10 for pulling or dragging skid base 10 with or without the cooling module. Additional attachment members 18 may be arranged to extend upwardly from each side skid member 12 and may each include an attachment hole therethrough. Attachment members 18 are useful for connecting cables, e.g., using shackle couplings, to skid base 10 for lifting or hoisting skid base 10 with or without the cooling module. As may be understood, attachment members 13 and 18 may be configured and specified for cable lifting, pulling, and/or dragging of skid base 10 loaded by the cooling module.

Skid base 10 may further include a plurality of riser setup brackets 22A, 22B, 22C, and 22D for releasable mounting of risers 20 in spaced relation along the length of the skid base in the support configuration, and a pair of riser storage brackets 24 respectively fixed to side skid members 12 near a rear end of each side skid member for releasable mounting of risers 20 closely adjacent one another in the transport configuration. Riser setup brackets 22A, 22B, 22C, and 22D and riser storage brackets 24 will be described in greater detail below.

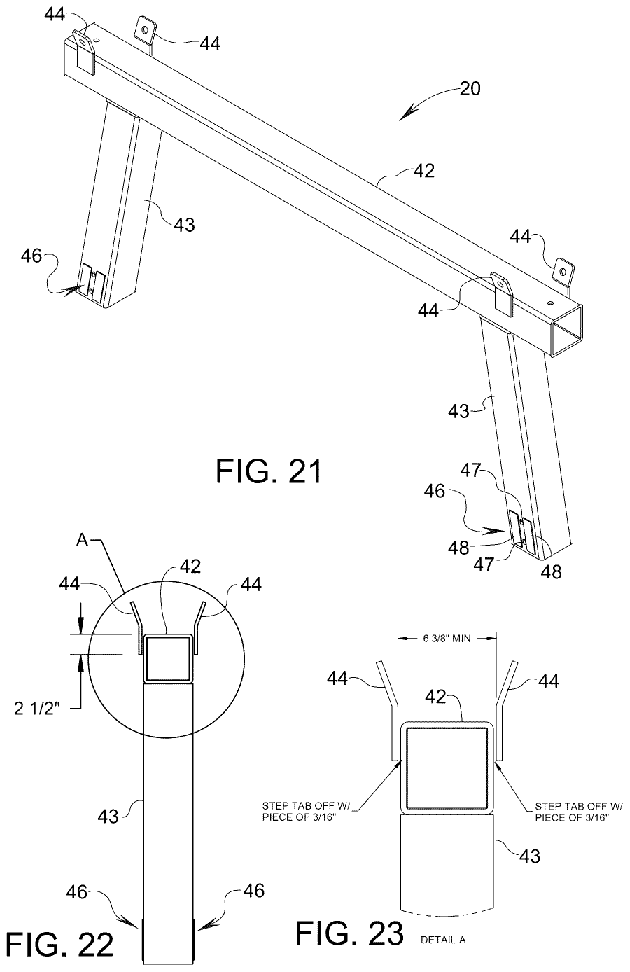

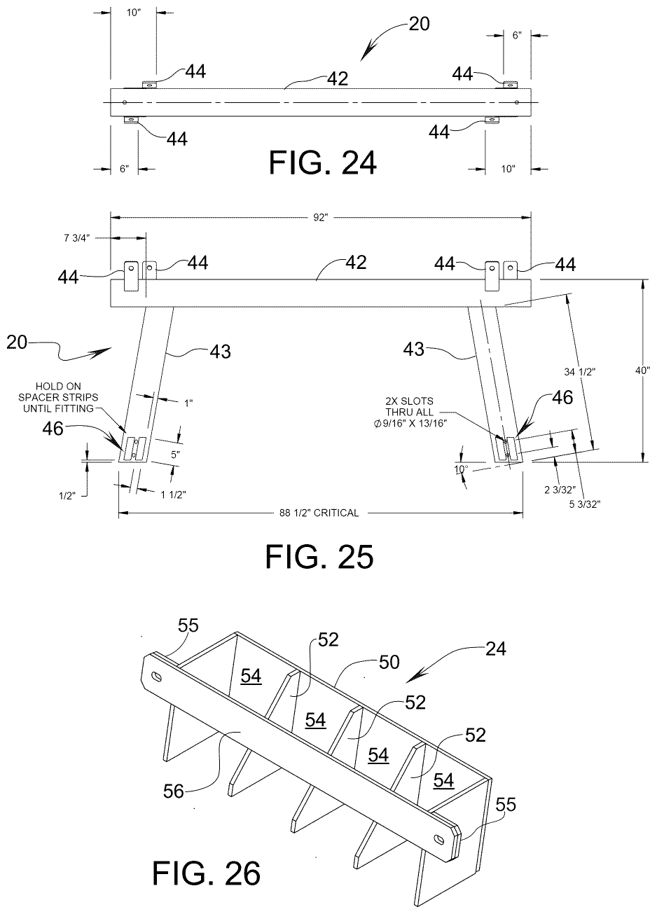

Risers 20 are now described with reference to FIGS. 21-25. Each riser 20 may be a steel weldment including a transverse support member 42 attached to a pair of support legs 43 on opposite sides of the support member. Each riser 20 may include a plurality guide tabs 44 extending vertically from support member 42 near the juncture of support member 42 with legs 43. An upper portion of each guide tab 44 may be bent outward away from support member 42 so that the guide tabs 44 act as a funneling guide for receiving and aligning a corresponding transverse cross-beam CB of the cooling module directly on top of the support member 42 as the cooling module is lowered onto risers 20 in the support configuration. Front and rear mounting interfaces 46 may be provided at a lower base portion of each support leg 43 for attaching legs 43 to skid base 10 between an associated facing pair of riser setup brackets 22A-22D, 22B-22C, or 22C-22D. Each mounting interface 46 may have a pair of fastener slots 47 arranged between two reinforcement plates 48. Support member 42 may be at least as long as the transverse cross-beam CB of the cooling module in the transverse direction to fully support the cooling module. Support legs 43 may be inclined slightly toward one another as they approach support member 42 from below.

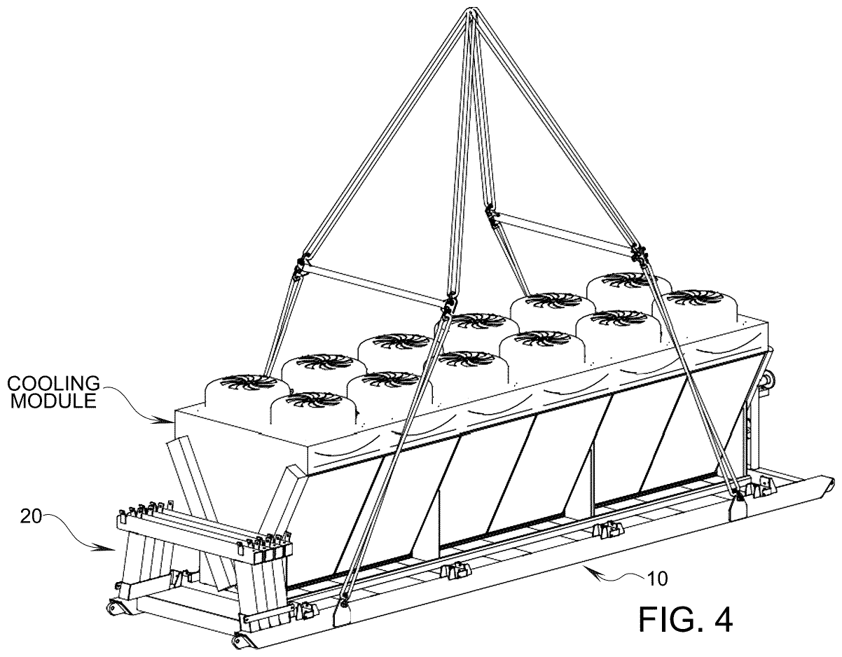

An embodiment of riser storage bracket 24 is shown in FIG. 26. Riser storage bracket 24 may include an inner wall 50, a pair of end plates 52 at opposite ends of inner wall 50, and a plurality of divider plates 53 located at spaced intervals along inner wall 50 to define a plurality of recesses 54 sized to slidably receive a lower base portion of a corresponding riser support leg 43. Inner wall 50 may be inclined at an angle from vertical to match the incline angle of support legs 43 of risers 20. Riser storage bracket 24 may further comprise a pair of end tabs 55 respectively extending from end plates 52 and flush with outer edges of the end plates and a clamping rail 56 releasably attachable to end tabs 55 by threaded fasteners (not shown). As may be understood, when clamping rail 56 is unattached, the bottom leg portions of risers 20 may be inserted into and removed from recesses 54, and when clamping rail 56 is attached to end tabs 55, risers 20 are secured in the riser storage bracket 24. As mentioned above, a riser storage bracket 24 is provided on each side skid members 12 of skid base 10. Thus, riser storage brackets 24 facilitate storage of risers at an end of skid base 12 in the transport configuration, thereby allowing space for cooling module to be secured directly on skid base 10 as shown in FIG. 4.

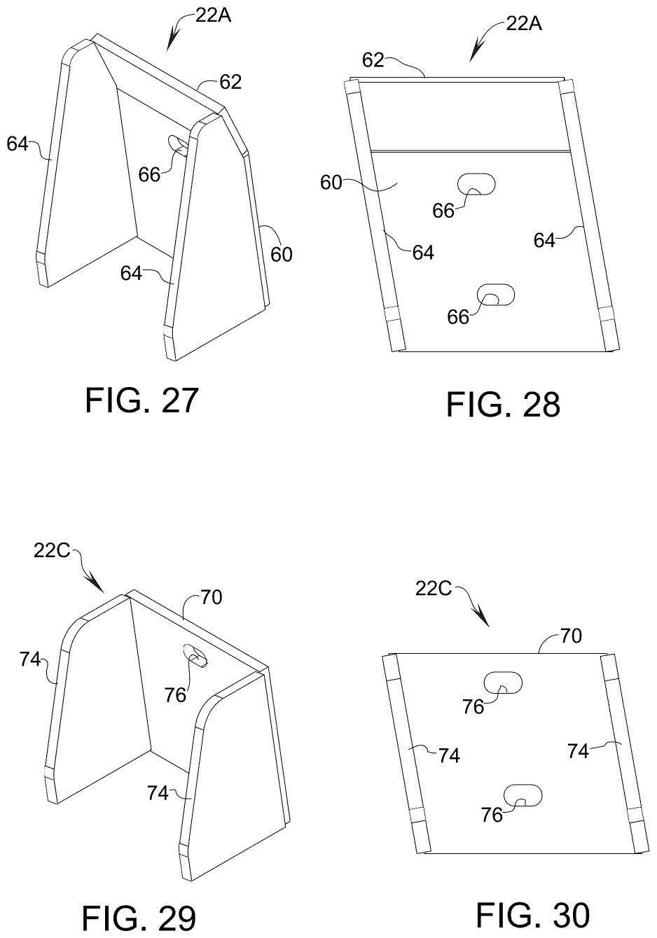

Riser setup brackets 22A-22D are now described with reference to FIGS. 27-30. FIGS. 27 and 28 show tall riser setup bracket 22A. As may be understood, riser setup bracket 22B is another tall setup bracket that is a mirror image of tall riser setup bracket 22A. Tall riser setup brackets 22A, 22B each include a vertical face plate 60, an inclined extension plate 62 at the top of face plate 60, and a pair of side gussets 64 extending behind face plate 60 and extension plate 62. Face pate 60 includes a pair of fastener slots 66 therethrough. Face plate 60 may be angled inward to match the incline angle of an associated riser leg 43 and fastener slots 66 may be arranged such that the fastener slots 47 of an associated riser leg 43 can be aligned with fastener slots 66.

FIGS. 29 and 30 show short riser setup bracket 22C. As may be understood, riser setup bracket 22D is another short setup bracket that is a mirror image of short riser setup bracket 22C. Short riser setup brackets 22C, 22D each include a vertical face plate 70 and a pair of side gussets 74 extending behind face plate 70. Face pate 70 includes a pair of fastener slots 76 therethrough. As may be understood from FIG. 30, face plate 70 may be angled inward to match the incline angle of an associated riser leg 43 and fastener slots 76 may be arranged such that the fastener slots 47 of an associated riser leg 43 can be aligned with fastener slots 76.

Thus, when risers 20 are positioned with their legs 43 between facing pairs of riser setup brackets 22A-22D, 22B-22C, or 22C-22D, threaded fasteners (not shown) may be installed through the fastener slots 66, 76 to secure the risers in the support configuration shown in FIG. 2.

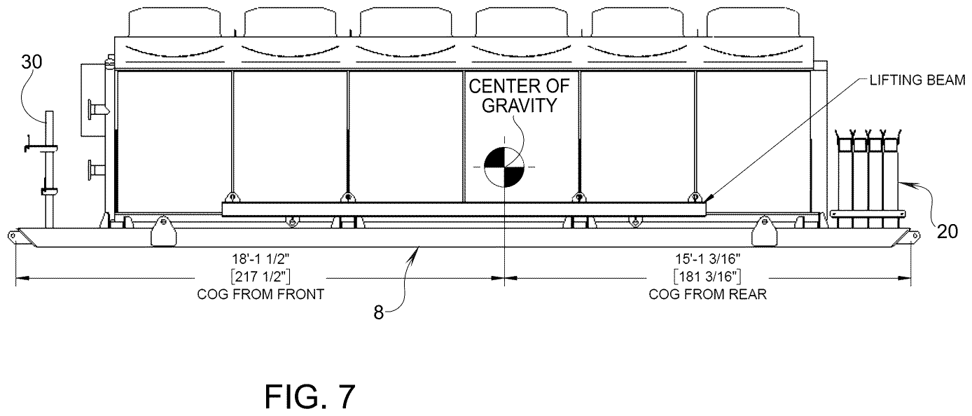

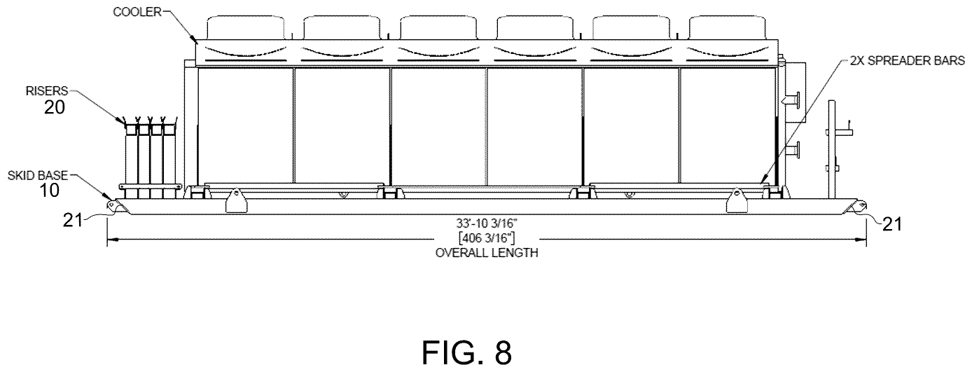

As shown in FIGS. 3 and 7, a lifting beam used for certain hoisting operations may be stored along skid base 10 in the transport configuration. Likewise, as shown in FIG. 8, a pair of cable spreader bars used for certain hoisting operations may be stored along skid base 10 on a side of the skid base opposite from the lifting beam in the transport configuration.

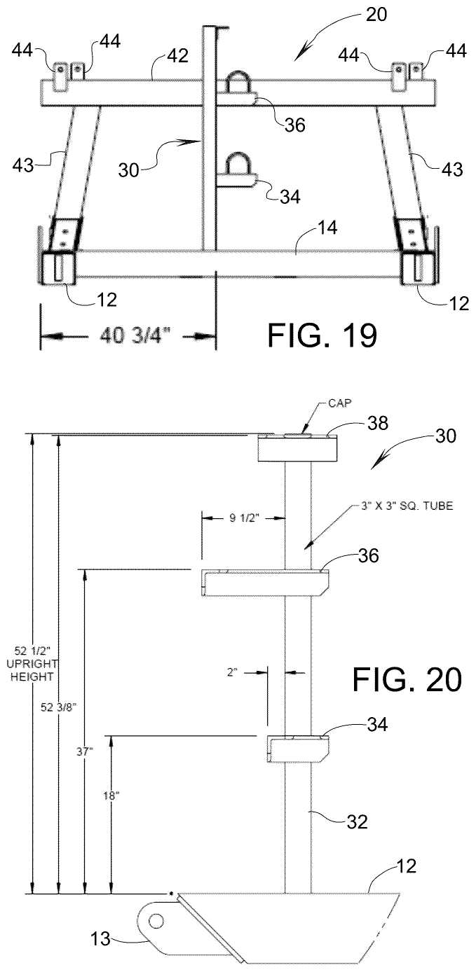

Pipe assembly stanchion 30 may be arranged at a front of skid base 10 to support and organize inlet and outlet pipe assemblies connected to the cooling module as shown in FIG. 5. In one embodiment shown in FIGS. 19 and 20, stanchion 30 may include a vertical post 32, a lower pipe bracket 34 fixed to vertical post 32, an upper pipe bracket 36 fixed to vertical post 32 above lower pipe bracket 34, and an end cap 38 attached at the top of vertical post 32. Lower and upper pipe brackets 34, 36 are configured to enable piping connected to the cooling module to be releasably clamped thereto, for example by U-bolts, when the cooling module is supported on risers 20 for jobsite operation.

Transport skid apparatus 8 allows for efficient and load-balanced transport of a cooling module to a jobsite and setup of the cooling module at an elevation at least four feet above ground level to minimize influx of dust and dirt. Transport skid apparatus 8 also facilitates the connection of piping to the cooling module at the jobsite.

While the disclosure sets forth exemplary embodiments, the detailed description is not intended to limit the scope of the disclosure to the particular forms set forth. The disclosure is intended to cover such alternatives, modifications and equivalents of the described embodiments as may be included within the scope of the claims.

What is claimed is:

1. A transport skid apparatus comprising:
a plurality of risers each having a horizontal support member and a pair of riser legs coupled to the support member;
a skid base having a front end and a rear end spaced in a longitudinal direction from the front end, the skid base including a pair of longitudinal side skid members and a plurality of transverse cross-members connecting the pair of side skid members to one another;
a pair of riser storage brackets fixed to the skid base and configured to removably receive the plurality of risers in a transport configuration of the transport skid apparatus; and
a plurality of riser setup brackets fixed to the skid base and configured to removably receive the plurality of risers in a support configuration of the transport skid apparatus;
wherein the pair of riser storage brackets are configured such that the plurality of risers are concentrated adjacent one another in the storage configuration;
wherein the plurality of riser setup brackets are positioned such that the plurality of risers are spaced apart from one another along a length of the skid base in the support configuration.

2. The transport skid apparatus according to claim 1, wherein the pair of riser storage brackets are fixed to the skid base near the front end or the rear end of the skid base.

3. The transport skid apparatus according to claim 1, wherein the plurality of riser setup brackets includes associated pairs of facing setup brackets, each associated pair of facing setup brackets being fixed to one of the pair of longitudinal side skid members and arranged to receive a portion of one of the pair of riser legs of one of the plurality of risers therebetween.

4. The transport skid apparatus according to claim 3, wherein each associated pair of facing setup brackets and each portion of one of the pair of riser legs are configured for securing the portion of one of the pair of riser legs between the associated pair of facing setup brackets using threaded fasteners.

5. The transport skid apparatus according to claim 3, wherein the associated pairs of facing setup brackets are arranged at a longitudinal location on the skid base corresponding to a longitudinal location of one of the plurality of transverse cross-members.

6. The transport skid apparatus according to claim 1, further comprising a plurality of attachment members fixed to the pair of longitudinal side skid members, each of the plurality of attachment members being configured for attaching a cable to the skid base.

7. The transport skid apparatus according to claim 1, further comprising a pipe assembly stanchion fixed to the skid base near the front end of the skid base.

8. The transport skid apparatus according to claim 1, wherein each of the plurality of risers includes a plurality guide tabs extending vertically from the horizontal support member.

9. The transport skid apparatus according to claim 1, wherein each of the pair of riser storage brackets includes an inner wall, a pair of end plates at opposite ends of the inner wall, and a plurality of divider plates located at spaced intervals along the inner wall to define a plurality of recesses sized to slidably receive a lower base portion of a corresponding riser leg of one of the plurality of risers.

10. The transport skid apparatus according to claim 9, wherein each of the pair of riser storage brackets further includes a clamping rail releasably attachable to the pair of end plates of the riser storage bracket, wherein the clamping rail secures the plurality of risers in the riser storage bracket when the clamping rail is attached to the pair of end plates.
